(19) United States
(12) Patent Application Publication
(10) Pub. No.: US 2024/0417262 A1
(43) Pub. Date: Dec. 19, 2024

(54) PROCESS FOR PRODUCING CARBON NANO ONIONS

(71) Applicant: Elemental Advanced Materials, Inc., Houston, TX (US)

(72) Inventors: Ian Bishop, Houston, TX (US); Ronald G. Presswood, JR., Houston, TX (US)

(21) Appl. No.: 18/662,317

(22) Filed: May 13, 2024

Related U.S. Application Data
(60) Provisional application No. 63/465,689, filed on May 11, 2023.

(51) Int. Cl. C01B 32/18

(52) U.S. Cl. CPC C01B 32/18; C01P 2004/34

(57) ABSTRACT

Methods and systems are described for the synthesis of carbon nano onions and other materials from carbon precursors. Embodiments include systems and processes for producing CNOs also known as carbon onions or multi-layered fullerenes, from an unrecyclable gas or materials containing a carbon source, in a molten metal or metal alloy bath as well as the CNOs produced therefrom. Various embodiments may utilize a molten aluminum or molten aluminum alloy bath. Certain embodiments utilize a molten aluminum bath as the reactant. Nitrogen can be either vented to the atmosphere or captured.

### CROSS REFERENCE TO RELATED INFORMATION

This application claims the benefit of United States of America priority application No. 63/465,689 filed on May 11, 2023, titled “Process for Producing Carbon Nano Onions (CNOs), Other Carbon Allotropes and Materials/Nanomaterials Prepared Therefrom,” the contents of which are hereby incorporated herein in its entirety. This application is a continuation-in-part of U.S. patent application Ser. No. 18/415,066, titled “Process for Producing Graphene, Other Carbon Allotropes and Materials,” the contents of which are hereby incorporated herein in its entirety. This application is a continuation-in-part of U.S. patent application Ser. No. 17/750,613, titled, “Gasification or Liquefaction of Coal Using a Metal Reactant Alloy Composition”, filed May 23, 2022; which is a continuation of U.S. patent application Ser. No. 16/434,771, now U.S. patent Ser. No. 11/359,253, titled, “Gasification or Liquefaction of Coal Using a Metal Reactant Alloy Composition”, filed Jun. 7, 2019; which is a continuation of U.S. patent application Ser. No. 14/973,243, now U.S. Pat. No. 10,316,375, titled, “Gasification or Liquefaction of Coal Using a Metal Reactant Alloy Composition”, filed Dec. 17, 2015; which is a continuation of U.S. patent application Ser. No. 13/487,430, now U.S. Pat. No. 9,216,905, titled, “Gasification or Liquefaction of Coal Using a Metal Reactant Alloy Composition”, filed Jun. 4, 2012; which claims the benefit of U.S. Provisional Patent Application No. 61/493,247, filed Jun. 3, 2011, titled, “Gasification or Liquefaction of Coal Using a Metal Reactant Alloy Composition”, the contents of which are hereby incorporated herein in its entirety.

### TECHNICAL FIELD

The present disclosure generally relates to the technical field of synthesis of carbon nano onions.

### BACKGROUND

Carbon nano onions (CNOs) are also known as multi-shell fullerenes characterized by mostly concentric shells of carbon atoms.

The synthesis of CNOs, has been highly dependent on carbon sources (e.g., carbon-rich gases) and a carbon seed such as a nanodiamond. Likewise, the purity of metals or metal mix involved in the synthesis of carbon nanomaterials plays an important role in reaction yield, crystallinity, and number of layers of the CNOs.

A variety of methods for synthesis of CNOs have been reported since their initial discovery by Ugarte when exposing carbon soot to intense electron irradiation. A common method of synthesis of CNOs consists in the application of nanodiamond as initial seed or starting material followed by thermal treatment or electron irradiation. Additionally, CNOs are traditionally obtained by arch discharge of graphite in liquids (e.g., liquid nitrogen or water). Larger CNOs are commonly obtained by reactions between a carbide source with a CuCl2·2H2O. Moreover, larger CNOs (above 30 nm diameter) are obtained by combustion of naphthalene.

Although the current methods of synthesis of CNOs rely on conventional techniques, specific sources of carbon, most demand nanodiamonds as seed or starting point, and high temperatures. Therefore, the production of CNOs has mostly been limited to few grams per synthesis batch, limiting commercial production.

There continues to be a need for the development of alternative processes for producing CNOs at an industrial scale using carbon rich gases, free from additional catalysts, seeds, or purification steps.

### SUMMARY

One embodiment under the present disclosure comprises a method for preparing carbon nano onions using a molten metal, molten metal alloy or metal alloy. The method comprises thermally treating a carbon precursor above 600° C. to induce graphitization.

Another embodiment possible method embodiment under the present disclosure is a method for manufacturing carbon nano onions. The method comprises interacting a carbon precursor with a catalyst in a controlled environment, where the reaction is carried-out above 600° C. to induce graphitization.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 shows a basic process flow and system embodiment;

FIG. 2 illustrates a reaction vessel embodiment under the present disclosure;

FIG. 3 shows a detailed cross-sectional view of the reaction vessel wall;

FIG. 4 shows a modified reaction vessel embodiment incorporating a vortex;

FIG. 5 shows a flow-chart of a method embodiment under the present disclosure;

FIG. 6 shows a flow-chart of a method embodiment under the present disclosure;

FIGS. 7A-7F show SEM images of the sample (ER-CNOs-01) treated at 600-1200° C. using acetylene gas as a carbon precursor and aluminum alloy as catalyst;

FIGS. 8A-8J show TEM images of the sample (ER-CNO-01) treated at 600-1200° C. using unpurified acetylene gas as carbon precursor and aluminum alloy as catalyst;

FIG. 9 shows Raman spectra of sample ER-CNO-01 treated at 600-1200° C. using unpurified acetylene gas as carbon precursor and aluminum alloy as catalyst; and

FIG. 10 shows Thermal Gravimetric (TGA) results of sample ER-CNO-01. The ramp was obtained from 30° C. to 950° C., heating rate of 10° C./minute. The analysis One analysis was done in synthetic air.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenges in the field of production of CNOs, carbon onions, or multi-layered fullerenes, as identified above. There continues to be a need for the development of alternative processes for producing carbon structures under conditions applicable to an industrial scale using unrecyclable carbon and metals.

Certain aspects of the disclosure and their embodiments may provide solutions to these or other challenges. The present disclosure relates to various embodiments of systems and processes for producing CNOs also known as carbon onions or multi-layered fullerenes, from an unrecyclable gas or materials containing a carbon source, in a molten metal, molten metal alloy, or metal alloy bath as well as the CNOs produced therefrom. Various embodiments may utilize a molten aluminum or molten aluminum alloy bath. Certain embodiments utilize a molten aluminum bath as the reactant. The ground feedstock may be introduced below the surface of the molten aluminum bath and react with the aluminum to decompose the feed stock. In other embodiments the feedstock may be added to a molten bath from above the surface. In the process, materials such as elemental carbon, sulfur, copper, iron, and rare earth and heavy metals and molecular hydrogen, and nitrogen, or other materials can be removed from the molten bath. Methane and other hydrocarbons can break down in the bath to e.g., hydrogen and carbon, the carbon forming e.g., CNOs. In some embodiments some materials, like nitrogen or hydrogen can be vented to the atmosphere or captured.

Certain embodiments may provide one or more of the following technical advantages. Advantages can include (re) capture of a variety of materials, all of which can be reused and/or sold. This can make the described embodiments a truly “green”, cleantech and zero waste solution.

Some of the embodiments contemplated herein will now be described more fully with reference to the accompanying drawings. Embodiments are provided by way of example to convey the scope of the subject matter to those skilled in the art. Additional objects and features of the present compound, compositions, methods and uses will become more apparent upon reading of the following non-restrictive description of exemplary embodiments and examples section, which should not be interpreted as limiting the scope of the present disclosure.

Certain embodiments utilize a molten metal as the primary reactant, such as aluminum or an aluminum alloy bath. The aluminum can also be alloyed with other elements including, but not limited to, zinc, iron, germanium, copper, silicon and calcium. Other metals and metal alloys such as calcium and silicon are also envisioned.

In the process, excess heat can be generated and can be used to facilitate other processes such as cogeneration of power. The excess heat generated by the process is a function of the makeup of the carbon precursor feedstock or gases in the feed.

When the feed stock contains other compounds, those compounds can also be decomposed or captured. For example, if the feed stock contains inorganic compounds, such as chlorine, the process will produce an aluminum salt, in this case aluminum chloride. The present disclosure also provides methods and systems for capturing heavy metals, such as, but not limited to mercury or rare earth metals, which are often found in consumer electronics or munitions. In the process, the molten metal bath breaks down the metal compounds as they are introduced into the molten metal bath. As additional aluminum is added to the bath, the heavy metals settle to the bottom of the reaction vessels and are removed from the reaction vessel. While some aluminum may be entrained in the heavy metals that are removed from the bottom of the reaction vessel, the aluminum can be removed and refined, and the heavy metals can be captured.

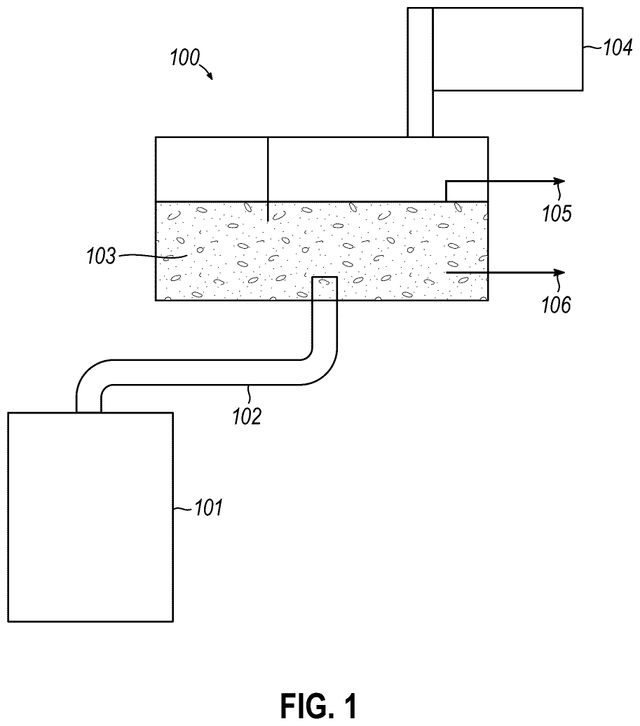

FIG. 1 shows one possible embodiment 100 under the present disclosure. In the basic process, ground material is introduced below the surface of the molten metal bath 103 using an injection feed system 101 through feed line 102. The elemental material, such as carbon, sulfur and the like, is captured 104, less dense secondary compounds are removed from the surface of bath 105, and denser secondary compounds are removed from the bottom of the bath 106. While this has been described as a method to recycle plastics, electronics, munitions or propellants, use of this method to recycle other organic compounds, such as, but not limited to rubbers, coal, coke, oils and tars are also contemplated.

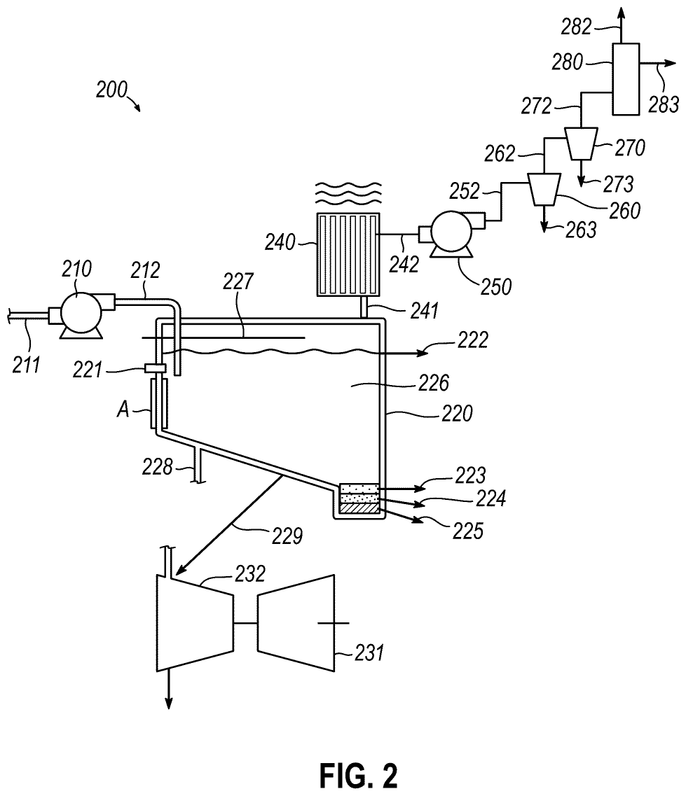

FIG. 2 shows a further possible process flow embodiment 200. While the process described discusses processing recycling plastics, electronics, munitions, propellants, and other materials can be processed. The ground feed stock is introduced into the treatment process through blower feed line 211. Blower 210, which may be another type of injector, is used to inject the ground feed stock into reaction vessel 220 through injection line 212. Injection line 212 introduces the ground feed stock, which is entrained in an inert gas such as nitrogen, or an active gas such as but not limited to Hydrogen, propylene, natural gas, below the surface of the molten aluminum compound 226. Injection line 212 must be sufficiently below the surface of the molten aluminum compound 226 to allow for sufficient mixing. The heavy products of the reaction, typically the heavy metals described above, will settle out in the reaction vessel. The reaction vessel typically has a sloped bottom, however other designs such conical bottoms and the like can be utilized. Once the heavy products settle out, they are collected using a collection line from the top, a pump or collection lines 223, 224, and 225. Collection lines 223, 224, and 225 allow for heavy metals of different densities to be removed. Depending on the size of the process, the heavy products can be continuously removed, or a batch removal process can be used.

Reaction vessel 220 also includes an aluminum feed line 221, which is used to supply additional aluminum compound to replace that consumed by the reaction with the ground feed stock. Additional heat may be required during start-up, for example. Heater 227 is provided for this purpose. Heater 227 can be any type of heater, including radiative, inductive, and convective. For example, heater 227 would be a microwave heater or a radio frequency heater wherein the frequency is tuned for the metal alloy used.

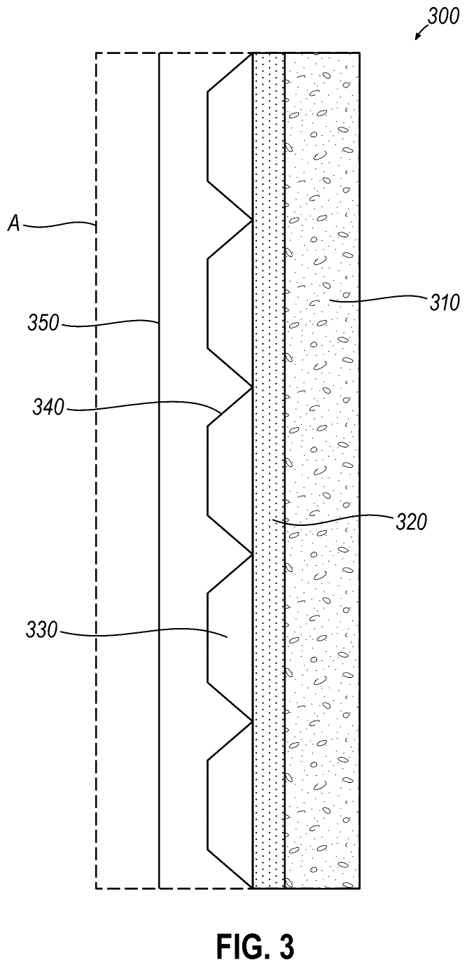

The heat generated by the process is preferably removed. Section A, which is shown in more detail in FIG. 3, shows one way the heat can be removed from the process. The reaction vessel 220 is lined with a refractory material 310, which protects the vessel wall 320. Cooling plate 330 is attached to the vessel wall 320 and cooling media (e.g., air, water, other fluid) is circulated in the channels created between the cooling plant 330 and the vessel wall 320. Insulation 340 surrounds the cooling plate to maximize heat recovery, as well as for safety purposes. Once the cooling media picks up the heat generated from the process, it can be either sent to a cooling tower or the heat can be recovered and used for other purposes. If the process is used in a facility that needs a hot water source, then the heat recovery system can be designed for this purpose. However, the heat can also be used to generate electricity.

Turning back to FIG. 2, a steam turbine electric generation process is represented. In this case, the cooling water is introduced thorough cooling feed 228. As the cooling water travels around the reaction vessel 220, it picks up heat and steam is generated. The steam generated is then sent via steam line 229 to steam turbine 232. The steam passes through the turbine and as it condenses, turns the turbine blades of turbine 232. Turbine 232 is coupled to generator 231. As the turbine turns the rotor of generator 231 though the stator, it generates electricity. While this process is only briefly described, this steam turbine-electric generator process is well known in the art. And any steam turbine-electric generator process could be utilized.

Also, as described above, the reaction can also produce elemental carbon, elemental sulfur, molecular nitrogen and molecular hydrogen, or other materials. These can be removed from the reaction vessel using blower 250. Blower 250 can e.g., pull high temperature elemental carbon, elemental sulfur, molecular nitrogen and molecular hydrogen from the reaction vessel 220 through heat exchanger feed line 241 into heat exchanger 240. Heat exchanger 240 will then cool this material to enable further processing. Heat exchanger 240 can be any heat exchanger, however in the preferred embodiment, heat exchanger 240 is a forced air heat exchanger, however other heat exchangers, are also envisioned. The process stream then leaves the heat exchanger through line 242 and passes through blower 250 and blower discharge line 252 into two cyclone separators. The first separator 260 separates out carbon from process stream. The carbon is collected though separation line 263. The remaining process stream proceeds to the second separator 270, which separates out sulfur from the process stream. The sulfur may be removed using a cold finger as the stream is cooled to less than 444 degrees Celsius. The sulfur is collected through separation line 273. The remaining process stream, which may include gaseous nitrogen and hydrogen, is then separated in separator unit 280 (e.g., cryo unit, Pressure Swing Absorber (PSA), membrane, or other method to separate the nitrogen from hydrogen).

Below is a limited list of possible ground feed stock that may be recycled, and the resulting elemental outputs produced by the reactions within the molten metal bath.

Poly Vinyl Chloride: 6(C2H3Cl)n+2Al→(12C+9H2+2AlCl₃

Polypropylene: (C3H6)n→(3C+3H2)n

PET: (C10H8O4)n+(3/2Al)n→(10C+4H2+4/3Al2O3)n

Polycarbonate: (C16H14O3)n+(2Al)n→(16C+7H2+Al2O₃)n

ABS: (C8H8*C4H6*C3H3N)n→(15C+17/2H2+1N)n

4-(tert-butyl)styrene (butyl styrene): (CH3)3C6H4CH═CH2→11C+8H2

Nylon 66: (3C12H22N2O2)n+4Al→(36C+33H2+3N2+2Al2O3)n

Dibutyl Phthalate: 3C16H22O4+8Al→48C+33H2+4Al2O3

Diphenylamine: 2C12H11N+0Al→24C+22H2+N2

### Nitrocellulose:

6C6H9(NO2)O5+12Al→36C+27H2+3N2+6Al2O3
2C6H9(NO2)2O5+12Al→12C+9H2+N2+6Al2O3
6C6H9(NO2)3O5+44Al→36C+27H2+9N2+22Al2O3

Dinitrotoluene: 3C7H6N2O4+8Al→21C+9H2+3N2+4Al2O3

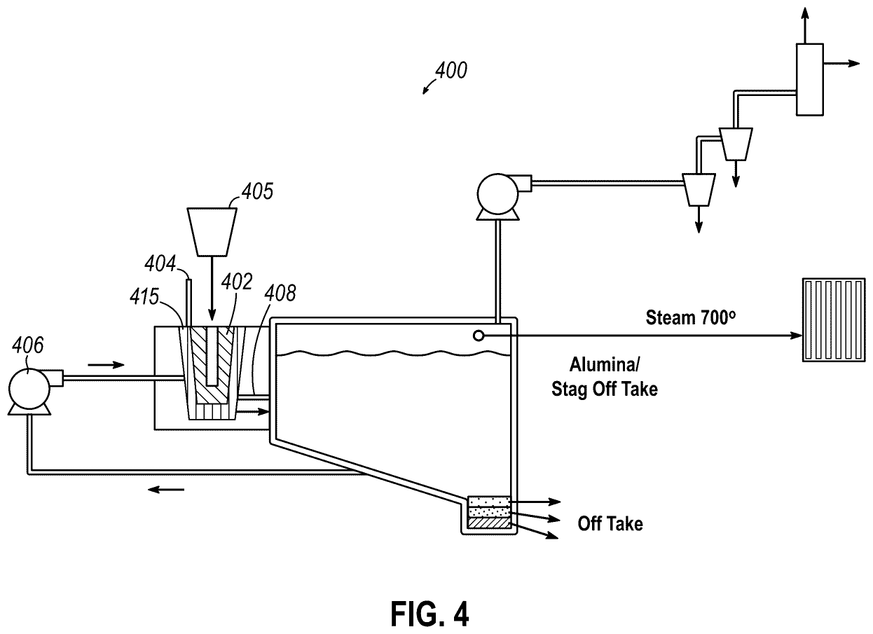

FIG. 4 illustrates another possible embodiment. FIG. 4 shows a modified process flow 400 using a vortex entry. As with the process described in FIG. 2, the modified process enables recycling of e.g., plastics, electronics, coal, coke, munitions or propellants. Instead of being directly injected into the aluminum bath, the ground feed stock is introduced into the treatment process through line fed by a vortex 402. The vortex 402 is formed within a ceramic bowl 415 by pumping in molten aluminum or aluminum alloy. The molten aluminum or aluminum alloy may be added through a new aluminum input line 404, or it may be recirculated from the aluminum bath using a pump 406. The ground feed stock (which may include any of the materials above that need to be recycled) may then be introduced into the ceramic bowl 415 through a gravity feed 405. The ground feed stock mixes with the molten aluminum or aluminum alloy and the mixture is pulled to the bottom of the bowl from the rotation of the vortex 402. The bottom of the ceramic bowl 415 may have a connecting line 408 to the aluminum bath, and the mixture of ground feed stock and molten aluminum or aluminum alloy enters the aluminum bath from the connecting line 408. Other aspects of the modified process flow 400 are similar to that shown with the flow in FIG. 2.

The vortex entry illustrated in FIG. 4 allows for some benefits over other injection systems. The vortex allows better mixing of the ground feed stock with the molten aluminum or aluminum alloy, which allows the recycling reactions to occur more efficiently. Additionally, because the ground feed stock has already mixed with the molten aluminum in the ceramic bowl 415, the temperature of the mixture has an opportunity to equalize, and the temperature may be relatively close to the temperature of the molten aluminum within the bath. Accordingly, there is less localized cooling, and a more consistent temperature gradient, at the entry injection point when the vortex entry is used.

As described above, once the feed stock enters the aluminum bath or the vortex, then reactions of the ground feed stock material with the aluminum or aluminum alloy bath will begin. The denser materials will begin to settle while the lighter materials will rise. The lightest materials, such as gas will bubble to the surface, to be recovered there.

Embodiments of the present processes allow the optional application of single metals, salt-derivate metals, alloys, metal nanostructures or a combination thereof in some variations of the process.

Furthermore, embodiments of the present processes generally do not require further treatment such as a chemical pre-treatment of the carbon source and/or a chemical post-treatment of the obtained carbon nano onions. Accordingly, since the present methods do not generally apply any harsh chemical conditions such as acids, bases, or organic solvents during the synthesis or to pre-treat the carbon source or its final product, the present method should be considered as a cleantech. Certain embodiments can comprise a “one-pot” synthesis setting.

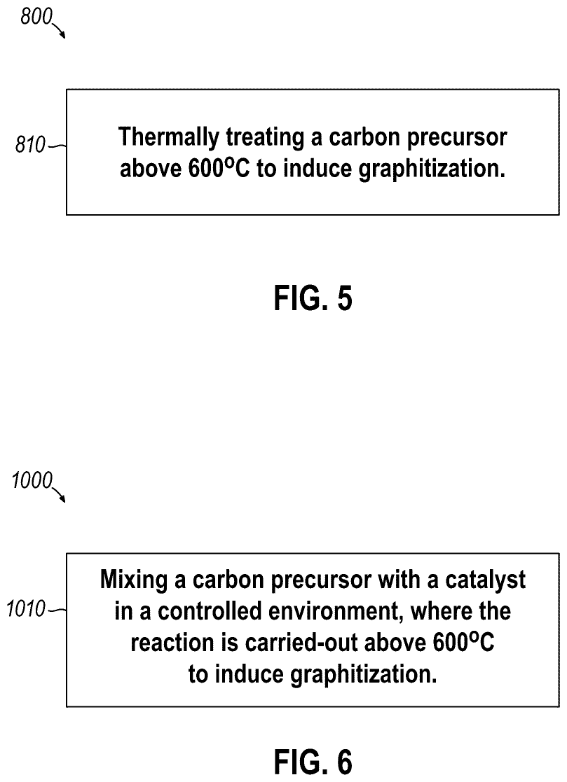

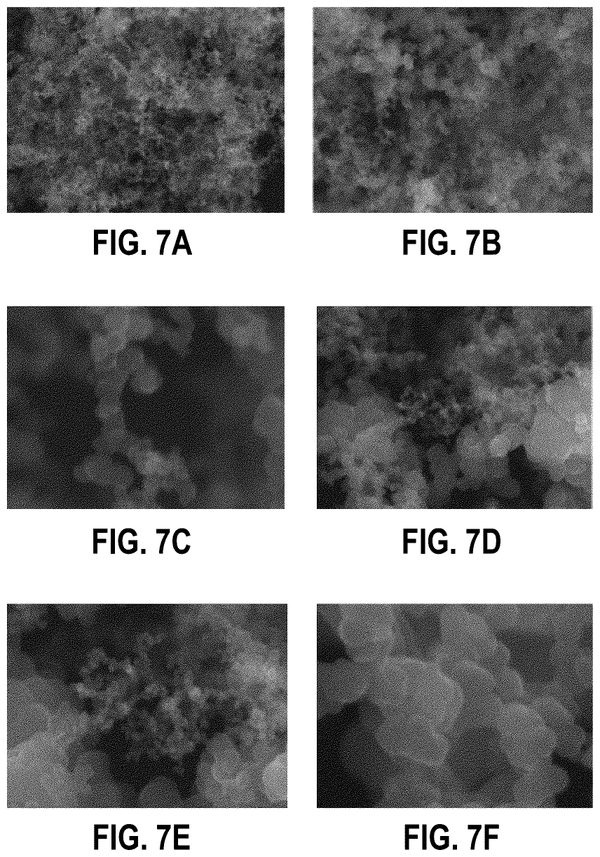

More specifically, the concepts described herein therefore relate to processes and systems for the preparation of carbon nano onions using alloys, metal, molten alloys, molten metal or molten metals nanostructures. One possible method embodiment is shown in FIG. 5. Method 800 is a method of preparing carbon nano onions using a molten metal or metal alloy. Step 810 is thermally treating a carbon precursor above 600° C. to induce graphitization. Another possible method is shown in FIG. 6. Method 1000 is a method for manufacturing carbon nano onions. Step 1010 is mixing a carbon precursor with a catalyst in a controlled environment, where the reaction is carried-out above 600° C. to induce graphitization.

Methods 800 and 1000 can comprise a variety of additional, alternative, or optional steps or other variations. For example, steps 810 or 1010 could comprise at least one of the steps of:
thermally treating a gas containing a carbon source at a temperature above 600° C. to induce graphitization and produce graphitized carbon; or.
thermally treating a carbon containing material source at a temperature above 600° C. to induce graphitization and produce a graphitized carbon; or.
thermally treating the carbon source containing carbon rich materials and carbon rich gas at a temperature above 600° C. to induce graphitization and produce a graphitized carbon; or
thermally treating until gasification, the carbon source containing carbon rich materials in an individual oven or heated container combined with a direct or indirect delivery of the nearly formed carbon rich gas into the system to thermally treat the carbon source above 500° C.

The above-described processes (which may be referred to as thermal treatments) can comprise a variety of additional, alternative, or optional steps or other variations. For example, the methods can further include additional/secondary thermal treatments. For example, the methods can further comprise optionally thermally treating the carbon sources at a temperature within the range of 150° C. to 1600° C. in the presence of inert gas to eliminate residual amorphous carbon. In other embodiments, a step can involve optionally thermally treating the carbon sources at a temperature within the range of 150° C. to 1600° C. in the presence of oxygen to eliminate residual amorphous carbon. In other embodiments, a step can involve optionally thermally treating the carbon sources from steps at a temperature within the range of 150° C. to 1600° C. under vacuum to eliminate residual amorphous carbon. In some variations, a step can involve optionally thermally treating the carbon products at a temperature within the range of 150° C. to 1600° C. under vacuum, or presence of oxygen, or inert gas, to eliminate residual amorphous carbon. Some of these processes/steps can exclude/include injection of hydrogen.

In certain embodiments, the carbon source comprises a landfill gas, a carbon rich gas or recyclable or unrecyclable material, or a mixture of two or more thereof. In another embodiment, the carbon source comprises CO₂, acetylene, or a mixture thereof. In a further embodiment, the carbon source comprises CO₂, methane, or a mixture thereof. In yet another embodiment, the carbon source is an unrecyclable carbon rich material added in combination with a carbon rich gas, and the like. In other embodiments, the carbon source may also further comprise a high carbon material, not necessarily unrecyclable. For instance, the high carbon material is present in at least 50 wt. % of the total carbon source, or less than 50 wt. %, or less than 30 wt. %, or less than 20 wt. %.

In some embodiments, the treatment steps can be preferably carried out under an atmosphere containing inert gas or low air content, such as restricted air as defined herein or a mix of inert gas and low air, under normal atmospheric pressure or near normal atmospheric pressure other pressures are also envisioned.

In some variations thermal treatment steps may comprise at least one step carried out at a temperature above 600° C., for instance within the range of 700° C. and 1400° C., or 900° C. to 1300° C., or 900° C. to 1200° C., or 950° C. to 1100° C.

In some cases, the process may further comprise a step of disaggregating the material after any of the thermal treatment steps described above, or at any point in the process. Micronization may be carried out by any conventional method, including, but not limited to, grinding, milling, pulverization, such as ball-milling, ring-and-puck grinding, jet pulverizing, jet milling, roll mills, and other wet or dry micronization techniques, etc.

Preferred embodiments of the certain processes can include the use of a metal catalyst, such as aluminum, aluminum alloys or other metals or metal alloys. In some embodiments, the metal catalyst may be in the form of a molten metal bath with the carbon source injected into the bath below the surface of the molten metal. In some cases, however, the processes may be adapted to further comprise the use of alloys, metal, molten alloys, molten metals or molten metals nanostructures during thermal treatment. The present processes may further be adjusted to obtain hybrid nano structures also known as hetero-nanostructures (e.g., 0D, 1D, and 2D materials) which may be directly produced by adding other inorganic nanomaterials mixed or not with the carbon source or by co-growth (or co-synthesis) by adding the chemical precursors of the other nanomaterials.

In some examples of the present disclosure, thermal treatment can be carried out at a temperature within the range of 150° C. to 1400° C., preferably 600° C. to 1000° C. Some thermal treatment may be carried out in the presence of inert gas.

In various examples, additional/secondary thermal treatment steps can be carried out to eliminate residual amorphous carbon if such residual amorphous carbon is present. For example, annealing steps may be included when the product obtained after CNOs' synthesis comprises more than 10% by weight, or more than 5% by weight, or more than 3% by weight of residual amorphous carbon or short chain aromatic carbon. For instance, such a annealing may be carried out at a temperature within the range of 100° C. to 400° C. under vacuum.

In certain embodiments, the content of residual amorphous carbon in the graphitized carbon (CNOs) is less than 5 wt. %, or less than 2 wt. %, or less than 1 wt. % after an initial thermal treatment.

The carbon nano onions are preferably produced by the present processes through a carbon conversion rate from the carbon source to graphene of at least 30 mol %, at least 40 mol %, or at least 50 mol %, or even more.

In certain examples, the carbon nano onions produced have an average particle size below 200 nm, or between about 0.1 nm and about 10 nm, or between about 1 and about 10 nm, or between about 2 nm and about 5 nm. The structure of the carbon nano onions may also include one or more of fullerenes, few-layer fullerenes, nanodiamonds, multi-layered fullerenes, pea pod like nanomaterials, graphene, carbon nano onions clusters wrapped by graphene, carbon shells, and other similar.

In other examples, the carbon nano onions clusters or pea pod-shaped nanomaterials produced have an average particle size above 20 nm, or between about 0.1 μm and about 10 μm, or between about 1 and about 10 μm, or between about 2 μm and about 5 μm. The structure of the carbon nano onions may also include one or more of fullerenes, few-layer fullerenes, nanodiamonds, multi-layered fullerenes, pea pod like nanomaterials, graphene, carbon nano onions clusters wrapped by graphene, carbon shells, and other similar.

The carbon nano onions may include fullerenes, few-layer carbon nano onions (2 to 20 layers), nanodiamonds, carbon shells, graphene, pea pod-shaped nanomaterials or a combination thereof. The carbon nano onions produced by the present process preferably has a carbon content of at least 80 mol %, at least 90 mol %, at least 95 mol %, or at least 97 mol %, preferably at least 98 mol %, or even at least 99 mol %.

In sum, the concepts described herein generally include synthesis of carbon nano onions from organic carbon sources, whether unrecyclable or not, gas or material, in ambient low air or inert gas conditions, i.e., with an additional gas flow, and without the use of a sealed or inert environment.

Alternatively, any other heating oven/device that simulates the conditions of the present synthetic method can be used to prepare the carbon nano onions and could even be applied to produce any graphene-like or carbon-nanostructure materials.

Carbon nano onions prepared by the present method may be used in a broad variety of known carbon nano onions applications, for instance, as nano sensors, bioimaging, batteries, quantum computing, additives in polymers/plastics, composites, coatings, paints, ceramics, 3D printing, electrodes, concrete, asphalt, etc.

The recitation of an embodiment or example for a variable herein includes that embodiment or example as a single embodiment or example or in combination with any other embodiments, examples, or portions thereof. The recitation of an embodiment herein includes that embodiment as any single embodiment or in combination with any other embodiments or portions thereof.

### EXAMPLES

The following non-limiting examples are illustrative embodiments and should not be construed as further limiting the scope of the present disclosure. These examples will be better understood with reference to the accompanying figures.

Unless otherwise indicated, all numbers expressing quantities of ingredients, reaction conditions, concentrations, properties, stabilities, and so forth used in the specification and claims are to be understood as being modified in all instances by the term “about.” At the very least, each numerical parameter should at least be construed in light of the number of reported significant digits and by applying ordinary rounding techniques. Accordingly, unless indicated to the contrary, the numerical parameters set forth in the present specification and attached claims are approximations that may vary depending upon the properties sought to be obtained. Notwithstanding that the numerical ranges and parameters setting forth the broad scope of the embodiments are approximations, the numerical values set forth in the specific examples are reported as precisely as possible. Any numerical value, however, inherently contain certain errors resulting from variations in experiments, testing measurements, statistical analyses, and such.

The synthesis method to manufacture carbon nano onions (CNOs) can comprise injecting a carbon precursor gas or a carbon rich material that was gasified in a reaction chamber with a catalyst in a controlled oxygen-free or low air environment. The reaction is carried-out at a range from 600° C. to 1400° C.

The process can be defined by the decomposition of the carbon precursor in at least carbon, and hydrogen atoms. The process may occur with or without the presence of nanodiamond seeds in the reaction chamber. The process's main products are carbon nano onions, carbon nano onions clusters wrapped and/or connected or not by graphene sheets, as well as pea pod like nanomaterials. The process may or may not produce graphene flakes as byproduct of the reaction. A doping process may occur as result of presence of oxygen during the carbon nano onions synthesis. In order to increase the number of layers of CNOs, some growths were carried out applying various reaction times, and temperatures. Thus, the system can be designed to vary the residence time of the carbon precursor gas to allow for the synthesis of various CNOS and CNOs clusters wrapped/and or connected by graphene layers. The different metal catalysts (e.g., Mg, Fe, Co, etc.,) or alloys may be added in the synthesis of the different carbon allotropes.

The reactor used was designed to operate at relatively low pressures, 3-5 psi gauge. It is envisioned that the reactor can be run at higher pressure up to several atmospheres. A carrier gas may or may not be used during the process. This carrier gas can be any of the short chain hydrocarbons, nitrogen, inert gases or hydrogen. A carrier gas may or may not be used during the process. In certain trials nitrogen was used as an carrier gas, but argon or the other carrier gases can be used.

The samples were prepared according with the table below:

TABLE 1
Synthesis of Carbon Materials Using
Various Carbon Sources and/or Mix

| Sample prepared | Carbon source | Carbon material obtained |
|---|---|---|
| ER-CNO-01 | Acetylene | CNOs |
| ER-CNO-02 | Natural gas mix | CNOs |
| ER-CNO-03 | Ethylene | CNOs |
| ER-CNO-04 | Propane | CNOs |
| ER-CNO-05 | Propylene | CNOs |
| ER-CNO-06 | Methane | CNOs |
| ER-CNO-07 | Styrene | CNOs |

In one set of trials synthesis of CNOs was achieved using ACETYLENE (ER-CNO-01). The results below are related to the synthesis described as follows: Unpurified acetylene gas was injected into the reactor as a carbon precursor with aluminum alloy as catalyst. An inert gas (e.g., nitrogen) was used as carrier to transport the CNOs and hydrogen from the reaction chamber to the collecting container. The temperature range at the reaction chamber was kept between 600° C. to 1200° C.

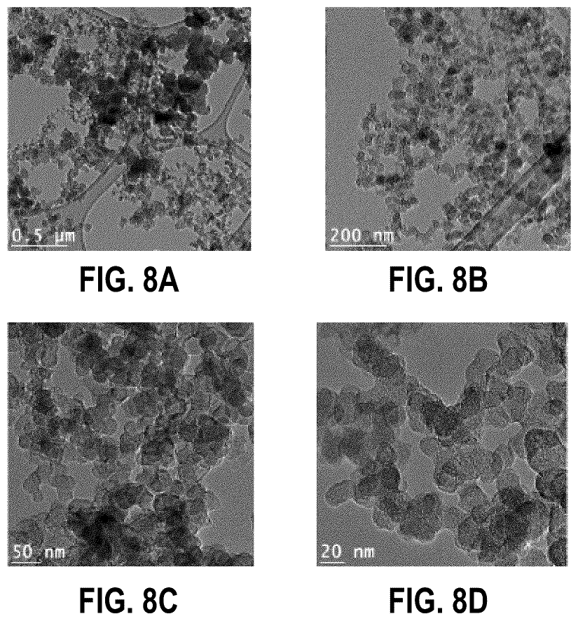

FIGS. 7A-7F show scanning electron microscopy images of CNOS (ER-CNO-01) from the trial. The sample was added on carbon tape. The images show particles aggregates below 1 μm, whereas higher resolution images (×250,000) show CNOs with diameter below 100 nm.

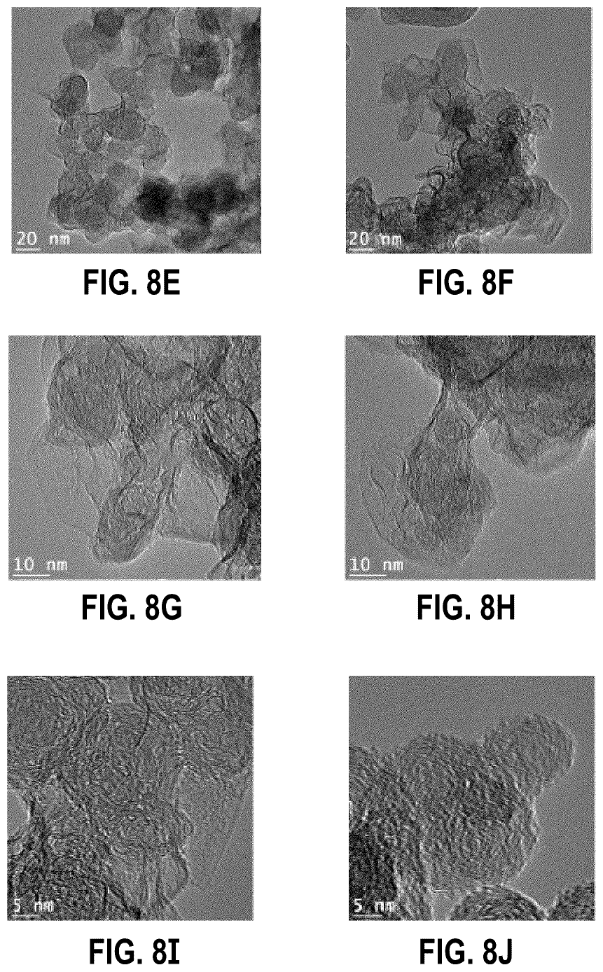

In another trial, a sample ER-CNO-01 was deposited on a nickel TEM grid coated with lacey carbon. FIGS. 8A-8J show transmission electron microscopy images of resulting CNOs (ER-CNO-01). FIGS. 8A-8J show CNOs aggregates (images of 0.5 μm to 20 nm bar). The images showing the 10 nm and 5 nm bars distinctively show CNOs with concentric fullerenes (or multi-layered fullerenes).

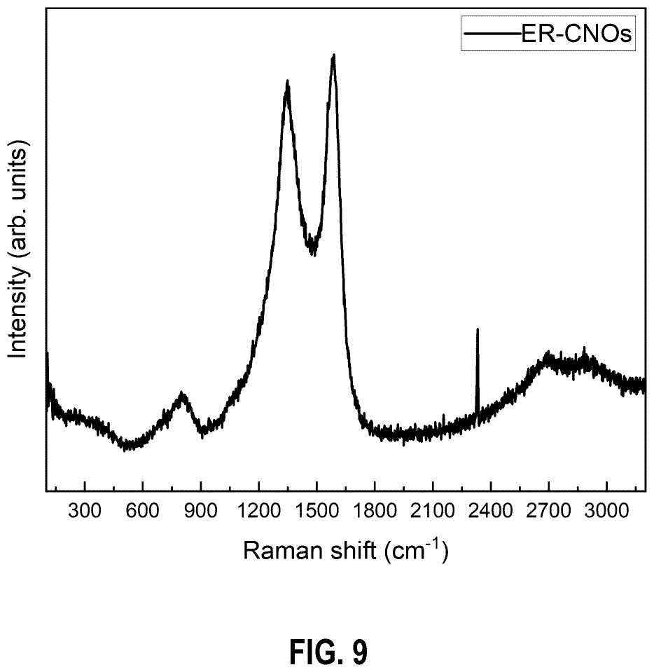

FIG. 9 shows Raman spectroscopy results of graphene (sample ER-CNO-01). The Raman spectrum show the peaks P1=250 cm⁻¹, P2=400 cm⁻¹, P3=714 cm⁻¹, and P4=861 cm⁻¹ related to the spectral identity of CNOs. Moreover, D and G bands are present around 1350 cm⁻¹ and 1580 cm⁻¹. A 2D band appears at 2660 cm⁻¹.

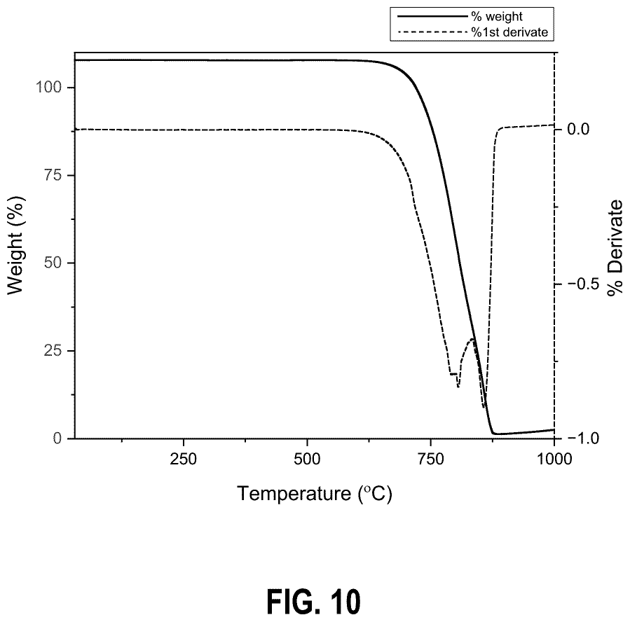

FIG. 10 shows a graph of thermal gravimetric analysis (TGA). TGA was performed using synthetic air, using ˜4 mg ramp from 30° C. to 950° C., heating rate of 10° C./minute. The analysis was done using synthetic air. The TGA results suggest a two-stage decomposition of the material starting above 750° C., the results are compatible with the ones observed in the literature.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

All technical and scientific terms and expressions used herein have the same definitions as those commonly understood by a person skilled in the art to which the present technology pertains. The definition of some terms and expressions used is nevertheless provided below. To the extent the definitions of terms in the publications, patents, and patent applications incorporated herein by reference are contrary to the definitions set forth in this specification, the definitions in this specification will control. The section headings used herein are for organizational purposes only and are not to be construed as limiting the subject matter disclosed.

The terminology used herein is for the purpose of describing particular embodiments only and is not intended to be limiting. It should be noted that the singular forms “a”, “an”, and “the” include plural forms as well, unless the content clearly dictates otherwise. Thus, for example, reference to a composition containing “a compound” also contemplates a mixture of two or more compounds. It should also be noted that the term “or” is generally employed in its sense including “and/or” unless the context clearly dictates otherwise. Furthermore, to the extent that the terms “including,” “includes”, “having”, “has”, “with”, or variants thereof are used in either the detailed description and/or the claims, such terms are intended to be inclusive in a manner similar to the term “comprising”.

The term “about” or “approximately” means within an acceptable error range for the particular value as determined by one of ordinary skill in the art, which will depend in part on how the value is measured or determined, i.e., the limitations of the measurement system. For example, “about” can mean within one or more than one standard deviation, as per the practice in the art. Alternatively, “about” can mean a range of up to 20%, preferably up to 10%, more preferably up to 5%, and more preferably still up to 1% of a given value. Where particular values are described in the application and claims, unless otherwise stated the term “about” meaning within an acceptable error range for the particular value should be assumed.

The expressions “carbon source”, “carbon-containing material” or other equivalent expressions as used herein include any source or material comprising a carbon source (such as methane, acetylene and/or unrecyclable carbon rich materials), and which may further comprise other materials, such as a material having a high carbon content (high carbon source). Non-limiting examples of carbon source include, a carbon rich gas or landfill gas or a mixture (e.g., acetylene, methane, CO2, non-methane organic compounds), recyclable or unrecyclable carbon rich materials, or a combination of it and the like.

As used herein, the expression “inert gas” or “low air” as used herein when referring to thermal treatment conditions means an atmosphere which contains air naturally present and or uniquely inert gas upon closing a lid or covering a heating vessel. During the thermal treatment, this atmosphere will likely contain other gas generated during the thermal treatment, such as hydrogen gas generated in situ.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be affected to the particular embodiments by those of skill in the art without departing from the scope of the description, which is defined solely by the appended claims.

What is claimed is:

1. A method (800) of preparing carbon nano onions using a molten metal, molten metal alloy, or metal alloy, the method comprising:
thermally treating (810) a carbon precursor above 600° C. to induce graphitization.

2. The method of claim 1, wherein the carbon precursor comprises at least one of: a gas containing a carbon source; a carbon containing material source; a carbon source containing carbon rich materials and carbon rich gas.

3. The method of claim 1, wherein the thermally treating comprises at least one of:
thermally treating a gas containing a carbon source at a temperature above 600° C. in a molten alloy bath to induce graphitization and produce graphitized carbon; or
thermally treating a carbon containing material source at a temperature above 600° C. to induce graphitization and produce a graphitized carbon; or
thermally treating the carbon source containing carbon rich materials and carbon rich gas at a temperature above 600° C. to induce graphitization and produce a graphitized carbon;
thermally treating until gasification, the carbon source containing carbon rich materials in an individual oven or heated container combined with a direct or indirect delivery of the nearly formed carbon rich gas into the system to thermally treat the carbon source above 500° C.

4. The method of claim 1, wherein the thermally treating yields a resultant product comprising carbon nano onions.

5. The method of claim 4, wherein thermally treating yields a carbon conversion from the carbon precursor to carbon nano onions of at least 30 mol %, at least 40 mol %, or at least 50 mol %.

6. The method of claim 4, wherein said carbon nano onions have a structure comprising at least one of: fullerenes; few-layered fullerenes; multi-layered fullerenes; nanodiamonds; graphene; carbon shells; pea pod-like nanomaterials; carbon nano onions clusters wrapped and/or connected by one or more graphene layers; or a combination of any of the foregoing.

7. The method of claim 1, further comprising treating the carbon precursor at a temperature within the range of 150° C. to 1600° C. in the presence of inert gas to eliminate residual amorphous carbon.

8. The method of claim 1, further comprising treating the carbon precursor at a temperature within the range of 150° C. to 1600° C. in the presence of oxygen to eliminate residual amorphous carbon.

9. The method of claim 1, treating the carbon precursor at a temperature within the range of 150° C. to 1600° C. under vacuum to eliminate residual amorphous carbon.

10. The method of claim 1, wherein the thermally treating comprises at least one of: excluding hydrogen; including hydrogen.

11. The method of claim 1, wherein the carbon precursor comprises at least one of: a carbon rich gas; a landfill gas; or a mixture of two or more thereof.

12. The method of claim 1, wherein the carbon precursor comprises a carbon rich recyclable or unrecyclable material, or a mixture thereof.

13. The method of claim 1, wherein the carbon precursor comprises one or more of: acetylene; methane; CO2; non-methane organic compounds.

14. The method of claim 1, wherein the thermally treating is carried out at a temperature within the range of 700° C. to 1400° C.

15. The method of claim 1, wherein the thermally treating is carried out at a temperature within the range of 800° C. to 1300° C.

16. The method of claim 1, wherein the thermally treating is carried out at a temperature within the range of 900° C. to 1200° C.

17. The method of claim 1, wherein the thermally treating is carried out at a temperature within the range of 950° C. to 1100° C.

18. The method of claim 1, further comprising micronizing a resultant product.

19. The method of claim 1, wherein the thermally treating is performed under at least one of: inert atmosphere; an atmosphere comprising low air; or a mix of low air and an inert gas.

20. A method (1000) for manufacturing carbon nano onions, comprising:
interacting (1010) a carbon precursor with a catalyst in a controlled environment, where the reaction is carried-out above 600° C. to induce graphitization.
